(19) United States
(12) Patent Application Publication
(10) Pub. No.: US 2015/0361958 A1
(43) Pub. Date: Dec. 17, 2015

(54) METHOD FOR REDUCING NOISE, VIBRATIONS, AND PRESSURE PULSATIONS ASSOCIATED WITH AERODYNAMIC INTERACTIONS BETWEEN WIND TURBINE BLADE WAKES AND THE WIND TURBINE TOWER

(71) Applicant: Eric James Wilmer Wood, Weston, MA (US)

(72) Inventor: Eric James Wilmer Wood, Weston, MA (US)

(21) Appl. No.: 14/732,822

(22) Filed: Jun. 8, 2015

Related U.S. Application Data
(60) Provisional application No. 61/997,963, filed on Jun. 16, 2014.

(51) Int. Cl. F03D 7/02; F03D 1/00; F03D 9/00; F03D 1/06; F03D 11/00; F03D 11/04

(52) U.S. Cl. CPC F03D 7/0296; F03D 11/0058; F03D 11/04; F03D 9/002; F03D 1/0666; F03D 1/001

(57) ABSTRACT

A noise, vibration, and pressure pulsation reducing collar for a wind turbine having a stationary tower, nacelle and rotor, a method of using such a reducing collar, and a wind turbine system comprising a said reducing collar are disclosed. The wind turbine includes rotating rotor blades, a nacelle containing an electric generator, and a stationary vertical supporting tower. The tower is provided with a reducing collar mounted thereon. The reducing collar can include elements of, e.g., rods or tubes or perforations or corrugations extending parallel to and along or adjacent to the outer surface of the tower and located downstream of the rotor blades.

### CROSS-REFERENCE TO RELATED APPLICATIONS

Benefits are claimed of the earlier filing date of Jul. 16, 2014 associated with provisional patent application No. 61/997,963, entitled Method for Reducing Noise, Vibrations, and Pressure Pulsations Associated with Aerodynamic Interactions Between Wind Turbine Blade Wakes and the Wind Turbine Tower, the entirety of which is hereby incorporated by reference herein.

### BACKGROUND OF INVENTION

The use of wind turbines to provide a renewable source of electricity is increasing. The principal components of a wind turbine include a tall vertical stationary supporting tower and, at the top of the tower, a bladed rotor and a nacelle, within which is an electric generator connected to the rotor by a shaft. The nacelle can also include a gearbox. Modern utility-grade wind turbine rotors typically include three blades, which are caused to rotate by the force of wind impinging on the wind turbine. This rotational force is transmitted, as mechanical energy, to the electric generator in the nacelle by the shaft of the rotor. The mechanical energy from the rotational force is converted to electrical energy by the generator, and the electrical energy then can be transmitted via wires to, e.g., a local utility grid.

A considerable amount of information about noise generated by and radiated from wind turbines has been and continues to be published in technical journals, magazines, and the popular press. Web searches provide a wide range of self-reported descriptions and concerns from some wind turbine neighbors about distress they attribute to wind turbine noise. As used herein, noise generated by and radiated from wind turbines includes, e.g., broadband sounds, tonal sounds, amplitude modulated sounds, low-frequency sounds, and infrasound.

A variety of methods have been proposed and some installed aimed at reducing noise from wind turbines. Examples from the prior art include: relocating the rotor from downstream to upstream of the support tower, enhanced nacelle designs to contain noise from generators and gear boxes, blade tip designs to reduce tip generated noise, enhanced trailing edge designs to reduce trailing edge generated noise, reducing blade pitch and rpm, and providing a solid shell outside the tower to absorb noise emitted by the tower. Each of these methods can be applied to address and reduce specific individual portions of the wind turbine noise. However, they do not address directly methods to control the noise, vibration, and pressure pulsations that are generated by the aerodynamic interactions between the wind turbine blade wakes and the tower, as does the invention described here. The present invention provides a new method for reducing unwanted noise, vibration, and pressure pulsations from operating wind turbines.

### SUMMARY OF INVENTION

The invention is directed in one aspect to a wind turbine system including a stationary supporting tower, a nacelle including an electric generator, a rotor including rotor blades and further including a blade wake dissipating device, or reducing collar, positioned on the supporting tower at least within a space between the tower and the rotor blades. When the rotor blades are in motion, the reducing collar operates to dissipate blade wakes from the rotating rotor blades, which can cause unwanted noise, vibration, and pressure pulsations, before they reach and aerodynamically interact with the solid surface of the tower.

In one embodiment, the reducing collar is in the form of a shell having open perforations, which is positioned around and attached to the supporting tower.

In another embodiment, the reducing collar shell comprises vertically oriented rods or tubes that surround the tower.

In a further embodiment, the reducing collar shell comprises open cross-shaped or screen elements in a lattice configuration.

In yet another embodiment, the reducing collar shell has a corrugated surface.

In another embodiment, the reducing collar of any surface configuration is a portion of a complete shell attached to the tower and positioned at least within a space between the tower and the rotor blades.

In another aspect, the invention is directed to a reducing collar that is configured to be attached to a wind turbine stationary supporting tower in a position to dissipate blade wakes from a wind turbine rotating rotor blades before the blade wakes can reach the solid surface of the supporting tower.

In a further aspect, the invention is directed to a method of dissipating blade wakes from rotating rotor blades of a wind turbine, which can cause unwanted noise, vibration, and pressure pulsations, before they reach and aerodynamically interact with the solid surface of the wind turbine tower by attaching a reducing collar to a wind turbine stationary tower in a position at least within a space between the tower and the rotor blades and operating wind turbine as usual.

It is the blade wake dissipation by the reducing collar disclosed herein that results in reduced generation of vibration, noise, and pressure pulsations from wind turbines outfitted as a system according to the invention.

The presently preferred embodiments are described above simply as a detailed exemplification of the invention without in anyway limiting the invention. It is to be understood that features of one can be used or combined with others to obtain further modified embodiments within the scope of the invention.

Advantages and features of the invention are outlined and described below, or may be clear from the below text and figures, or may be determined during application and experience with the invention.

### BRIEF DESCRIPTION OF DRAWINGS

The full disclosure of the present invention as set forth in the specification enabling, and including the best mode thereof, directed to one of ordinary skill in the art, makes reference to the following appended figures:

FIG. 1 is an oblique schematic view of a wind turbine according to the prior art showing a vertical stationary tower supporting at its top a rotor with three rotating blades, which is connected by a shaft to an electrical generator (not shown) located within a nacelle, also at the top of the tower;

FIG. 2 is an oblique schematic view of a wind turbine system according to the invention including a reducing collar in the form of a shell with open perforations surrounding and located along the vertical stationary tower of a prior art wind turbine, according to one embodiment of the present disclosure;

FIG. 3 is an oblique schematic view of a wind turbine system according to the invention including a reducing collar shell with vertically oriented rods or tubes surrounding and located along the vertical stationary tower, according to another embodiment of the present disclosure;

FIG. 4 is an oblique schematic view of a wind turbine system according to the invention including a reducing collar with open cross-shaped or screen elements surrounding and located along the vertical stationary tower, according to another embodiment of the present disclosure; and

FIG. 5 is an oblique schematic view of a wind turbine system according to the invention including a reducing collar configured as a corrugated metal shell surrounding and located along the vertical stationary tower, according to another embodiment of the present disclosure.

### DETAILED DESCRIPTION OF INVENTION

Reference now will be made in detail to embodiments of the invention, examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

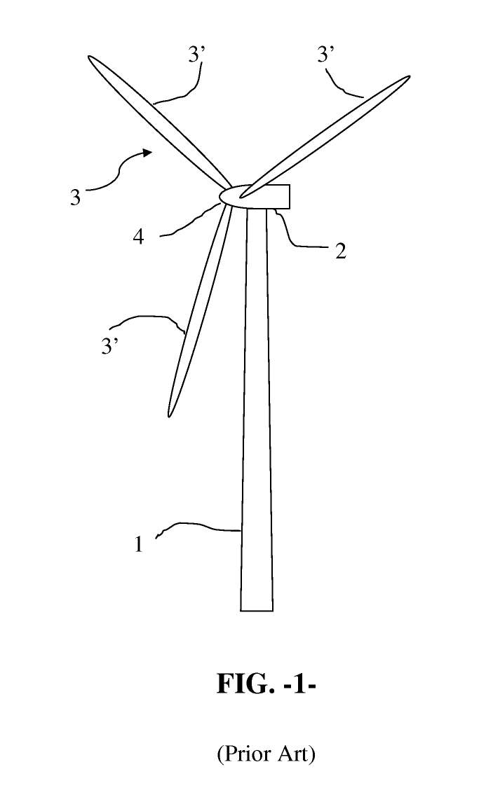

FIG. 1 illustrates a wind turbine of conventional construction according to the prior art. The wind turbine includes a tower 1 with a nacelle 2 mounted thereon. A rotor 3 having a plurality of blades 3′ is mounted to a rotor hub 4, which is in turn connected to a main flange that turns a main rotor shaft. The wind turbine power generation and control components including the rotor shaft are housed within the nacelle 2. The view of FIG. 1 is provided for illustrative purposes to place the present invention in an exemplary field of use. It should be appreciated that the invention is not limited to any particular type of wind turbine configuration.

A wind turbine such as that shown in FIG. 1 operates to produce electrical energy when rotor 3 is turned to face into the wind and rotor blades 3′ are permitted to rotate. The rotating blades 3′ turn the rotor shaft, causing the electric generator (both not shown) in nacelle 2 to convert mechanical energy to electrical energy.

Aerodynamic interactions between the wakes shed from rotating wind turbine blades 3′ and the stationary tower 1 occur at the following rate:

(wind turbine rpm/60)*(number of blades)=wake interactions per second

This rate results in 0.9 interactions each second, or 54 per minute, for a typical 3-blade wind turbine turning at 18 rpm.

Undesirable noise, vibration, and pressure pulsations are produced and radiated from the wind turbine each time the turbulent aerodynamic wakes shed from rotating blades 3′ flow to, encounter, and interact with stationary tower 1. The intensity and frequency of such noise, vibration, and pressure pulsations are related to the aerodynamic conditions of the turbulent wakes and the physical size of the tower 1.

In a wind turbine system according to the invention, a wind turbine as shown in FIG. 1 further includes a blade wake dissipating device, or reducing collar, positioned on the supporting tower at least within the space between the tower and the rotor blades. When the rotor blades are in motion, the reducing collar operates to dissipate blade wakes from the rotating rotor blades, which can cause unwanted noise, vibration, and pressure pulsations, before they can reach and aerodynamically interact with the solid surface of the tower. The arrangement of the reducing collar and the size and shape of its elements can dissipate the turbulent wakes as well as change their scale and frequency allowing for smoother aerodynamic conditions, thus advantageously reducing the noise, vibration, and pressure pulsations during operation of a wind turbine.

Not being bound by any theory, it is believed that wind turbine systems according to the invention including a reducing collar as shown and described herein operate with reduced vibration and reduced generation and radiation of noise and pressure pulsations associated with aerodynamic interactions between the wakes shed from rotating wind turbine blades and the stationary tower. Use of the disclosed reducing collar is simple to implement. The reducing collar can be installed before or after the wind turbine becomes operational.

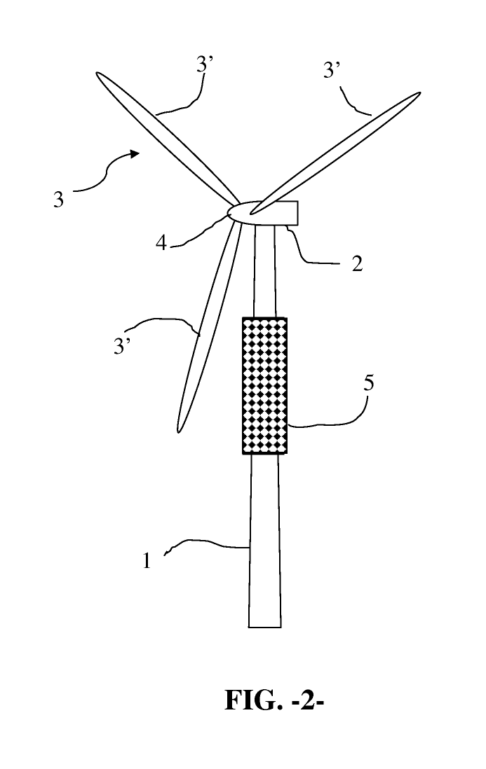

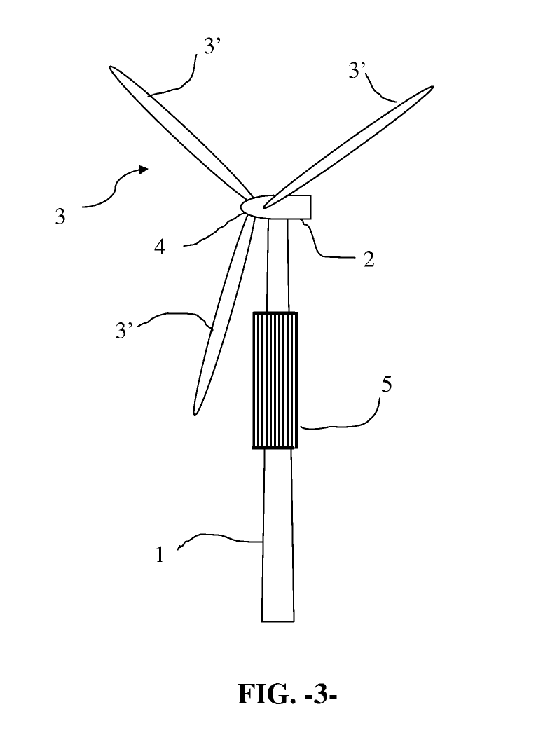

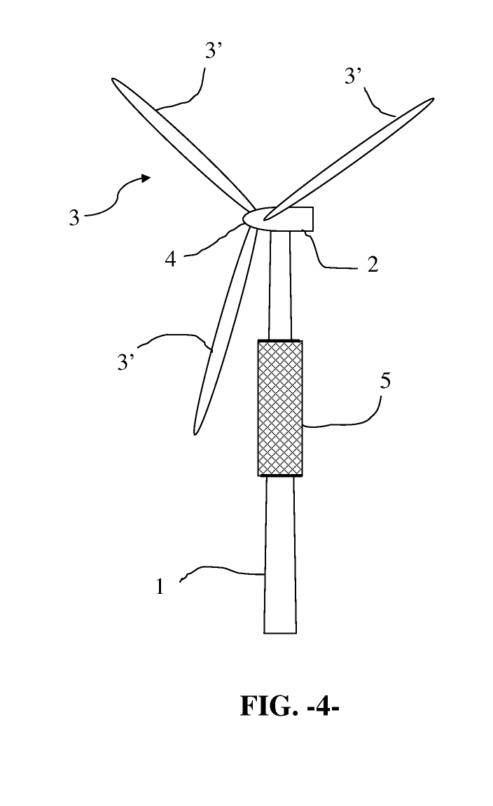

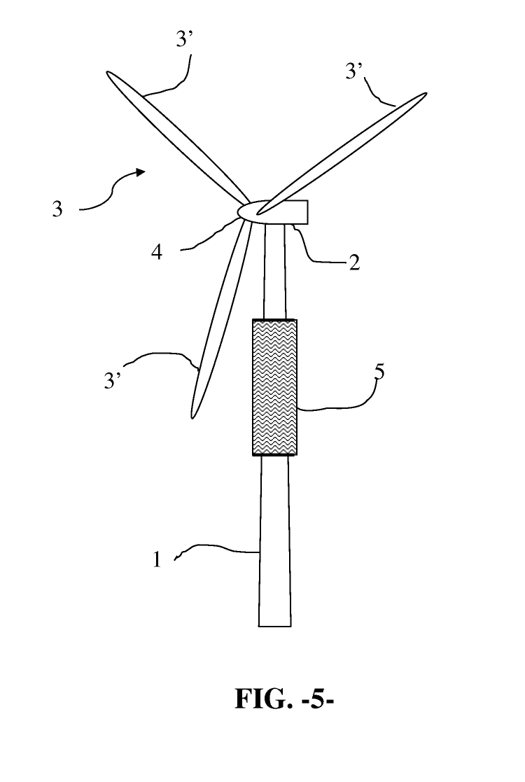

Referring now to FIGS. 2 through 5, which show exemplary structures for reducing collar 5, the invention is implemented by mounting a reducing collar shell 5 on the wind turbine stationary tower to dissipate the fluctuating pressure pulses associated with aerodynamic blade wakes interacting with the tower and thereby reduce vibration and noise generation and radiation associated with operation of the wind turbine. As an exemplary configuration, reducing collar shell 5 is shown as a cylinder of constant inner and outer diameter encircling and mounted on the turbine tower 1, the symmetry of said encircling cylindrical collar shell 5 thereby accommodating local winds from any direction and all orientations of rotor blades 3′ with respect to stationary tower 1. However, the reducing collar may be fabricated in any effective configuration, e.g., only partially surrounding the tower when limited directional relationships of local winds and rotor orientations are to be accommodated, or tapering closer to the tower at the top and/or bottom of the collar shell.

The inner diameter of a reducing collar 5 in the configuration as shown can be equal to and as small as the outer diameter of the tower 1 at the vertical elevation where reducing collar 5 is located. The outer diameter of a cylindrical reducing collar as shown can be less than and no greater than two times the distance (radius) between the tower centerline and the distance out to the rotating blades at the point where the reducing collar is located. Thus, approximately half of a cylindrical reducing collar 5 is located within the space between the tower 1 and rotating blades 3′ at any one time.

The length of the reducing collar is approximately 33% the length of the wind turbine rotating blades. Thus, for a wind turbine with 270 ft long blades for example, the reducing collar would be approximately 90 ft long. The reducing collar can be longer without reducing its effectiveness, such as 40%, 50%, 60%, 67%, or any percentage or range of percentages there between, or any other suitable percentage or range of percentages, of the length of the blades.

The appropriate cross-section size of the rods, tubes, perforations, and corrugations in the exemplary embodiments disclosed herein will depended on the aerodynamic characteristics and rotating rate of the blades as well as the diameter of the tower where the reducing collar is to be located. It is expected that the cross-section size will be on the order of 1-inch to 4-inches or more, or any other suitable size depending on the dimensions of the actual wind turbine where the reducing collar is to be installed.

The vertical position of the reducing collar as located on the tower is preferably opposite the outer one-third of the length of the blades as shown in FIGS. 2 through 5. The length of the reducing collar can be increased approximately 10% or more such that the lower elevation of the reducing collar extends below the blades from which turbulent wakes are generated and shed.

The reducing collar is fabricated from weather resistant and structurally sound materials, such as steel or aluminum. Alternatively, the collar material may be, e.g., fiber-reinforced polymer. It should be understood, however, that the collar material is not limited to the above disclosed materials and, rather, that any suitable materials can be used that are within the scope and spirit of the present disclosure.

The reducing collar is supported on the tower with the use of solid or resilient mounts. The mounts can be of steel or aluminum or fiber-reinforced polymer, as examples, and can be bolted or welded to the tower and the reducing collar. If used, resilient mounts would include vibration isolation.

Although the present invention has been fully described in connection with preferred embodiments, it is evident that modifications may be introduced within the scope thereof. Thus, it is intended that the present invention covers such modifications and variations as come within the scope of the appended claims and their equivalents.

What is claimed is:

1. A wind turbine system comprising:
a vertical, stationary tower, said tower comprising an exterior surface;
a nacelle comprising an electric generator;
a rotor comprising a plurality of rotor blades, wherein each blade of said plurality of blades is periodically aligned with said tower when said turbine system is in use and said rotor is in motion; and
a reducing collar positioned adjacent to and mounted on said tower at least partially within a space formed between the exterior surface of said tower and said aligned rotor blades.

2. The system of claim 1, wherein said reducing collar is in the form of a shell fully or partially surrounding said tower.

3. The system of claim 2, wherein said reducing collar shell is configured as a cylinder fully surrounding said tower.

4. The system of claim 2, wherein said reducing collar is configured as a partial cylinder partially surrounding said tower.

5. The system of claim 2, wherein said reducing collar shell has one or more solid portions and one or more open portions.

6. The system of claim 2, wherein said reducing collar shell is constructed of corrugated metal.

7. The system of claim 5, wherein said reducing collar shell comprises any one of rods, tubes, screens or perforations, as elements of said collar.

8. The system of claim 1, wherein said reducing collar comprises any one of steel, aluminum, or fiber-reinforced polymer.

9. A reducing collar configured to be mounted on a wind turbine,
wherein said wind turbine comprises:
a vertical, stationary tower, said tower comprising an exterior surface;
a nacelle comprising an electric generator; and
a rotor comprising a plurality of rotor blades, wherein each blade of said plurality of blades is periodically aligned with said tower when said turbine system is in use and said rotor is in motion; and
wherein said reducing collar is mounted on said wind turbine vertical, stationary tower in a position to dissipate blade wakes from said wind turbine rotating rotor blades before said blade wakes can reach the solid surface of said tower.

10. The reducing collar of claim 9, configured to be mounted on said wind turbine stationary tower at least partially within a space formed between the exterior surface of said tower and said aligned rotor blades.

11. A method of dissipating blade wakes from rotating rotor blades of a wind turbine, which can cause unwanted noise, vibration, and pressure pulsations, before the blade wakes can reach the solid surface of the wind turbine tower, said method comprising:
providing the reducing collar of claim 9;
attaching said reducing collar to a wind turbine stationary tower in a position at least partially within a space between the tower and the rotor blades; and
operating said wind turbine.
